(19) United States
(12) Patent Application Publication
(10) Pub. No.: US 2025/0335933 A1
(43) Pub. Date: Oct. 30, 2025

(54) SYSTEMS, METHODS, AND COMPUTER READABLE MEDIA FOR LANGUAGE-ACTION MODELS

(71) Applicant: Robert Stephenson, Clayton, NC (US)

(72) Inventor: Robert Stephenson, Clayton, NC (US)

(21) Appl. No.: 19/196,518

(22) Filed: May 1, 2025

Related U.S. Application Data
(63) Continuation of application No. 19/187,659, filed on Apr. 23, 2025, now abandoned.
(60) Provisional application No. 63/638,755, filed on Apr. 25, 2024.

(51) Int. Cl. G06Q 30/018

(52) U.S. Cl. CPC G06Q 30/018

(57) ABSTRACT

Systems and methods for storing a first language-action model in a first data storage device, wherein the first language-action model comprises a first set of key-value pairs, wherein the key corresponds to a unique word field. and wherein the value corresponds to an action field, receiving a first input from a first user, transmitting the first input to a first tokenization function, in response to transmitting the first input to the first tokenization function, receiving a first output from the first tokenization function, transmitting at least part of the first output to a first matching function, and determining, by the first matching function, a degree of match between the first output and a predetermined data item.

### CROSS-REFERENCE TO RELATED APPLICATIONS

This application is a Continuation of, and claims the benefit of U.S. application Ser. No. 19/187,659, filed on Apr. 23, 2025, which claims the benefit of the filing date of U.S. Provisional Application Ser. No. 63/638,755, filed on Apr. 25, 2024.

### TECHNICAL FIELD

This disclosure relates generally to systems comprising language-action models that allow integration of human oversight, fine-tuning, and/or calibration.

### BACKGROUND

In some cases, language models may suffer from drift, become non-performant and/or unusable for various applications, such as high stakes applications. In addition, manufacturing processes may be complex. Some processes must comply with standards. The consequences of non-compliance may be costly. For example, a process compliance failure in drug manufacturing may result in defective and dangerous drugs. Manufacturing process failures may be a result for various reasons. In some circumstances, operators may follow incorrect instructions. In some cases, supervisors may provide wrong or incomplete instructions to operators. In other cases, a supervisor may instruct an operator not to follow written instructions. In some cases, an operator may report a process violation to a supervisor, and the supervisor may incorrectly identify the process violation as normal.

In an illustrative example, an operator may reach a point in their training that they are not sure about and turn to their supervisor for support. The procedure may not be clear to them or there may be some confusion in the operator's understanding of the correct process. The supervisor may instruct the operator to perform a step that is not clear or stated differently than the procedure requested. The process has become misaligned at this point. The supervisor may instruct the operator to move forward with the incorrect process procedure.

Operators may become confused if they consistently receive incorrect or incomplete procedure instructions from supervisors. The operator may continue performing a non-compliant procedure as if the procedure was normal. Manufacturers may spend significant time and effort waiting for an audit to capture an issue that has occurred multiple times incorrectly and is rarely identified. What is needed is a highly controllable, customizable system including language models that allow integration of human oversight, fine-tuning, and/or calibration. This allows leveraging of language models in high stakes applications while mitigating risk of model drift.

### SUMMARY

Disclosed herein are systems and methods for storing a first language-action model in a first data storage device, wherein the first language-action model comprises a first set of key-value pairs, wherein the key corresponds to a unique word field. and wherein the value corresponds to an action field, receiving a first input from a first user, transmitting the first input to a first tokenization function, in response to transmitting the first input to the first tokenization function, receiving a first output from the first tokenization function, transmitting at least part of the first output to a first matching function, and determining, by the first matching function, a degree of match between the first output and a predetermined data item.

Further disclosed herein are methods for presenting a question to a user, receiving an answer to the question from the user, determining a degree of match between the received answer and a predetermined answer, and in response to determining the degree of match is less than a predetermined minimum, indicating the received answer did not comply with the predetermined answer. The question may ask what instruction the user received for a process operation. The received answer may be an instruction received by the user. The predetermined answer may be a standardized operation definition. The degree of match may be determined as a function of sentence embeddings encoded as vectors in a latent space by a pretrained transformer model for the received and predetermined answers. The degree of match may be determined at each step of a multiple operation process. Multiple degrees of match may be summed to determine an overall process compliance score.

### BRIEF DESCRIPTION OF THE DRAWINGS

FIG. 1 is a flowchart showing a high-level description of a language-action process, according to some embodiments herein.

FIG. 2 is a flowchart showing a high-level description of a language-action re-alignment process, according to some embodiments herein.

FIG. 3 is a flowchart showing a high-level description of an unknown word handling process, according to some embodiments herein.

FIG. 4 is a flowchart showing a high-level description of a surveying process, according to some embodiments herein.

FIG. 5A depicts an aspect of a re-alignment system, according to some embodiments.

FIG. 5B depicts an aspect of a lean management system, according to some embodiments.

FIG. 6A depicts an aspect of a re-alignment system, according to some embodiments.

FIG. 6B depicts an aspect of a re-alignment system, according to some embodiments.

FIG. 6C depicts an aspect of a re-alignment system, according to some embodiments.

FIG. 6D depicts an aspect of a re-alignment system, according to some embodiments.

### DETAILED DESCRIPTION

### Terminology

Patient—Individual who receives treatment.

User—Individual who is performing a process that will provide treatment.

HIPAA—Health Insurance Portability and Accountability Act.

UDI—Unique Device Identifier.

DHF—Design History File.

ML—Machine Learning, a computational method that is a sub-field of artificial intelligence and that enables a computer to learn to perform tasks by analyzing a large dataset without being explicitly programmed.

Algorithm—A step-by-step procedure for solving a problem or accomplishing some end. A finite set of unambiguous instructions that, given some set of initial conditions, can be performed in a prescribed sequence to achieve a certain goal and that has a recognizable set of end conditions. A precise rule (or set of rules) specifying how to solve some problem; a set of procedures guaranteed to find the solution to a problem. A precise step-by-step plan for a computational procedure that possibly begins with an input value and yields an output value in a finite number of steps.

Supervisor 1—Individual who is part of management and salaried.

Supervisor 2—Individual who is part of management and is either hourly or salaried. This is individual can be called a team lead, coordinator, scheduler, trainer, etc.

Manufacturer—Individual who is usually paid hourly and will perform controlled predetermined tasks that have an expected outcome.

SOP—Standard Operating Procedure

MBR—Master Batch Record

DHF—Design History File

Form—Product Form

Logbook—Record Log

IoMT—Internet of Medical Things

Controlled Document—A document that instructs an individual to do something that is intended to happen in a predetermined way.

CAPA—Corrective Action and Preventive Action.

LMS—Learning Management System

Validation—A process that is tested to prove an exact same outcome.

eDoc—A type of digital file that you can upload, store, or share online.

PHI—Protected health information—HIPAA as information that identifies a patient by name, or information that when taken together or used with other information may be used to identify a patient.

An implementation of the presently disclosed system may ensure that product compliance is identified and addressed at some or all levels of an organization. Such a system may match employee training methods and on-the-job instructions and verify whether correct instructions are being delivered to new employees in a continuous manner. The system may collect product compliance information to help improve compliance in the manufacturing of Current Good Manufacturing Practice (cGMP) products. This system may ensure that procedures are kept current and accurate. The feedback may align procedural misunderstanding and/or interpretation to support compliance. In addition, this system may be used to strengthen operators in cGMP and help companies with product compliance. The system may be used to ensure product compliance is at the highest level and ensure that any operators and VPs are aware of any misaligned steps or procedures being executed.

In an illustrative example, the exemplary disclosed system may be used by, or with, operators in a new position with less than 18 months of training. Such new operators may be asked compliance questions to advance the implementation of updating procedures and misaligned practices. Collected survey data may be evaluated from employees with less than a predetermined amount of experience in a new position. For example, collected survey data may be evaluated from employees with less than 18-months in a new position. Survey data may be used to identify process compliance in written, verbal and on-job training. Survey data may be used to identify misaligned process steps against procedures, policies, and guidelines. For each manufacturing process a survey questionnaire may be offered to employees to verify whether procedure failure has occurred, and whether a system output failure occurred from a requested input. A system output failure will be repeated if not addressed immediately and stopped from repeating in the future.

In an illustrative example, materials stored in corrugated boxes per procedure and signage should not be in component prep pass thru. In this example, an operator may tell their supervisor that corrugated material is in pass thru and the supervisor may instruct the operator that this is standard procedure, i.e., always done that way. In this example, the operator may be left confused, and the operator may continue performing the non-compliant procedure as if the procedure was normal or correct. This may be a result of a supervisor instructing the operator not to follow written instructions. In some cases, a supervisor may instruct an operator not to follow written instructions from the beginning, causing a complete breakdown of the quality management system. This could be identified in a survey questionnaire, in some cases. In this example, if the procedure is not updated to reflect new practice, or the material is not being removed in warehouse pass thru as expected, non-compliance will likely cause a manufacturing process output problem in the present or future.

However, this need not be the case. Instead, the operator could answer a survey question that would be included in a report so an issue could be addressed appropriately with the correct quality management system. The new system may collect operators survey data upfront, compare the survey data to the correct instructions from a standardized process definition and evaluate whether the instructions received by the operator were the correct instructions. This feedback and comparison evaluation loop can identify process and procedures misalignment immediately.

It may be inefficient to wait for an audit to capture an issue that has occurred multiple times incorrectly and is rarely identified. In an illustrative example, one of the first things an operator may experience in their training is reaching a point that they are not sure about. The unsure operator may turn to their supervisor for support. The procedure may not be clear to them or there may be some confusion in their understanding of the steps in the process. The supervisor may instruct the operator to perform steps that are in the wrong order, or the supervisor may omit essential steps from the instruction. The supervisor's instruction may not be clear or may be stated differently than the procedure requested. In such a case of a misaligned process, what is needed is to identify any gaps in the instructions and the supervisor's request. In accordance with the present disclosure, the operator may fill out a provided survey questionnaire to identify gaps in the instructions and the supervisor's request. This survey report may be automatically sent to management to capture and correct the confusion and determine if any training was incorrectly delivered to the operator. The presently disclosed system may be used to ensure product compliance is at the highest levels and ensure that any operators and Vice Presidents (VPs) are aware of any misaligned steps or procedures being executed.

An implementation of the present disclosure provides supervisors control over the process and enables identification of training needed for new operators, to troubleshoot away critical quality attributes in a controlled system. The systems and methods herein may help align process and procedural instructions. Such process and procedure alignment is not being addressed through legacy CAPA systems, in contrast with implementations in accordance with the present disclosure.

In some embodiments, systems and methods herein allow early-identification and/or prevention of compliance issues in real time. This may be advantageous for reducing reworks, deviations, nonconformances, and investigations, and may prevent corrective and preventive actions from occurring. This may be further advantageous to improve training knowledge and delivery methods, and to ensure that safe and quality products are being manufactured in a controlled process by identifying instructions that are misaligned and/or unintended for the approved process.

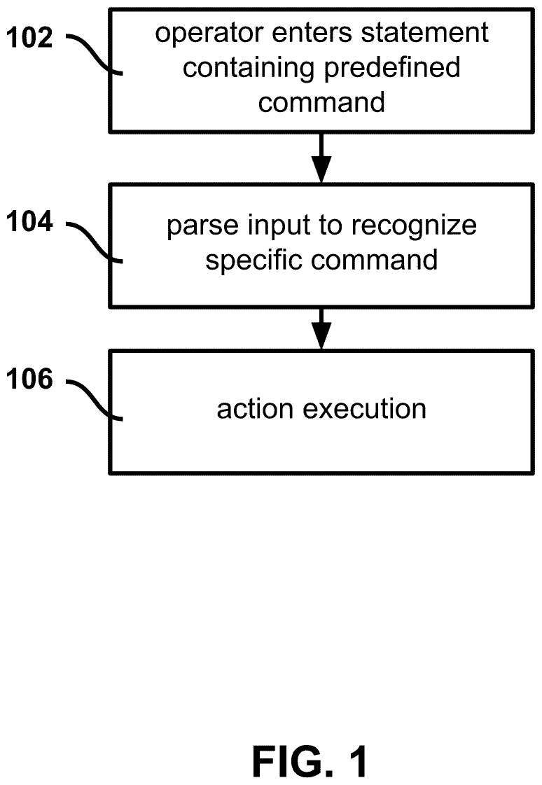

FIG. 1 is a flowchart showing a high-level description of a language-action process 100, according to some embodiments herein.

At step 102, a first user may be allowed to enter a first input. In some embodiments, the first user comprises an operator, associate, and/or employee, for example. In some embodiments, the first user comprises an operator, associate, and/or employee with greater than, or less than, a predefined amount of time and/or experience performing a task, or in a particular role or position, such as an operator, associate, and/or employee with less than 18 months of experience in a particular position, for example. It will be understood that any predefined amount of time and/or experience may be specified, determined, and/or utilized, according to embodiments herein. Similarly, it will be understood that any particular role or position may be specified, determined, and/or utilized, according to embodiments herein.

In some embodiments, an input may comprise a statement comprising or containing one or more predefined statements, actions, and/or commands.

For example, in some embodiments, an operator, associate, and/or employee may enter an input statement containing or comprising one or more commands via a form presented in a user interface (UI). For example, a form may be presented via a first UI using HTML/CSS.

At step 104, the user input is processed. In some embodiments, the user input processing comprises identifying, recognizing, parsing, analyzing, comparing, and/or matching the user input. In some embodiments, the user input processing comprises parsing the user input for recognition of, and/or matching with, one or more specific, predefined commands. For example, a first set or group of actions, such as a set of predefined commands, may be stored in one or more data storage devices, such as one or more databases.

At step 106, one or more actions are executed. In some embodiments, the one or more actions are determined based on the identification and/or recognition of one or more specific, predefined commands within the user input. For example, depending on the one or more commands identified in a user input from step 102, one or more actions will be determined, identified, and/or selected from a first set or group of stored actions. In some examples, the first set or group of actions may comprise one or more actions to 1) Skip a step (e.g., mark the step as skipped), 2) Backdate data (e.g., set a date to an earlier one), 3) Phantom a step (e.g., make it appear completed without actually doing it), 4) Make it pass (e.g., mark a step as passed), 5) Add more buffer or water (e.g., adjust parameters in the process), 6) Fill out a new record (e.g., create a new record in compliance with regulations).

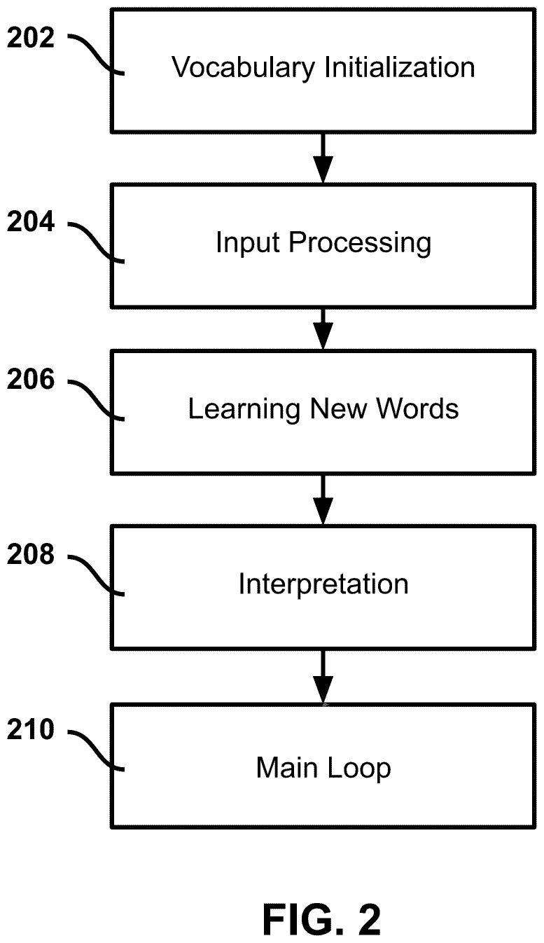

FIG. 2 is a flowchart showing a high-level description of a language-action re-alignment process 200, according to some embodiments herein.

At step 202, a current vocabulary, dictionary, and/or library initialization step is performed, carried out, and/or executed. In some embodiments, the current vocabulary, dictionary, and/or library may comprise a predefined dictionary of known words (e.g., “supervisor,” “result”, etc.) stored in one or more data storage devices, such as one or more databases. In some embodiments, each known word is associated with a meaning/definition/action field and/or a context field in the one or more data storage devices.

At step 204, a user input processing step is performed, carried out, and/or executed. In some embodiments, the user input processing comprises executing one or more functions. In some examples, the user input is supplied to one or more functions as a first variable. In some embodiments, the one or more functions comprise a tokenization function (e.g. “tokenize_input”) which splits a user input into words. In some embodiments, the one or more functions comprise a find unknown words function (e.g. “find_unkown_words”) which checks and identifies words that are not present in the current vocabulary.

At step 206, a learning process is performed, carried out, and/or executed if a determination is made that an unknown word has been identified. In some embodiments, the learning process comprises providing a request to the user for a definition of the unknown word. In response to receiving a definition for an unknown word (e.g. “flush”), the definition is stored in association with the word (i.e., added to the current vocabulary and/or library). Accordingly, a tailored and current vocabulary and/or library is maintained according to user preferences and/or specifications.

At step 208, an interpretation process is performed, carried out, and/or executed. In some embodiments, the interpretation process comprises executing one or more functions. In some examples, one or more known words are supplied to one or more functions as one or more variables. In some embodiments, the one or more functions comprises an input interpretation function (e.g. “interpret_input”) which replaces known words with their meanings for a basic interpretation.

At step 210, a main loop process is performed, carried out, and/or executed. In some embodiments, the main loop process comprises executing one or more functions and/or loops comprising repeating processes and/or one or more exit conditions/commands. In some examples, one or more user inputs are supplied to one or more functions and/or one or more loops as one or more variables. In some embodiments, the one or more functions and/or one or more loops continuously and/or repeatedly accept user input until an exit condition is met and/or an exit command is received. For example, an exit condition may comprise receiving one or more commands, such as a user “exit” command.

In some embodiments, users are allowed to enter a statement and/or question that challenges confusingly written, or verbal instructions that differ from the approved standard procedure due to misaligned instructions and/or guidance.

In some examples, a language-action re-alignment process may be performed according to one or more functions and/or processes specified by one or more computer programs stored on one or more computer readable media comprising:
python
import re
from typing import Dict
-# Initial vocabulary (known words and their meanings)
vocabulary: Dict [str, dict]={
“supervisor”: {“meaning”: “person in charge”, “context”: “general”},
“told”: {“meaning”: “instructed”, “context”: “general”},
“result”: {“meaning”: “output or outcome”, “context”: “general”},
“data”: {“meaning”: “information”, “context”: “general”},
“entry”: {“meaning”: “record”, “context”: “general”}
}
-# Function to tokenize input into words
def tokenize_input(text: str)->list:
return re.findall(r′\w+′, text.lower( ))
-# Function to check for unknown words
def find_unknown_words (tokens: list)->list:
return [word for word in tokens if word not in vocabulary]
-# Function to process input and learn new words
def process_input(user_input: str)->str:
tokens=tokenize_input(user_input)
unknown_words=find_unknown_words(tokens)
if unknown_words:
-# Prompt user for clarification on the first unknown word
word=unknown_words[0]
print(f“I don't understand what ‘{word}’ means in this context.”)
meaning=input(f“Can you explain what you mean by ‘{word}’?”)
-# Update vocabulary
vocabulary [word]={“meaning”: meaning, “context”: “user-defined”}
print(f“Got it! I've added ‘{word}’ to my vocabulary as ‘{meaning}’.”)
-# Interpret the input with the new word
interpreted=interpret_input(user_input, word, meaning)
return interpreted
else:
-# If all words are known, interpret the input directly
return interpret_input(user_input)
-# Function to interpret input based on vocabulary
def interpret_input(user_input: str, new_word: str=None, new_meaning: str=None)->str:
tokens=tokenize_input(user_input)
interpreted=[ ]
for token in tokens:
if token in vocabulary:
meaning=vocabulary [token][“meaning”]
interpreted.append(meaning if token!=new_word else new_meaning)
else:
interpreted.append(token) # Fallback for unhandled cases
return “Interpreted as:”+“ ”.join(interpreted)
-# Main interaction loop
def main( ):
print(“Hello! Enter a statement or question, and I'll process it.”)
print(“Type ‘exit’ to quit. \n”)
while True:
user_input=input(“You:”)
if user_input.lower( )==“exit”:
print(“Goodbye!”)
break
response=process_input(user_input)
print(f“System: {response}\n”)
-# Optional: Show current vocabulary
print(“Current vocabulary:”, {k: v [“meaning”] for k, v in vocabulary.items( )})
print( )
if name==“main”:
main( )

In some embodiments, systems and methods herein allow for detection and/or handling of new flagged words, rules, and/or statements from user input statements in natural language. In some examples, user statements and/or rules may include:
1) “Doing a phantom cleaning”
2) “back date data”
3) “forward date data”
4) “skipping a step”
5) “change a step”
6) “missing a step”
7) “an incomplete step”
8) “instructions are different in other procedures for the same step”
9) “instructions are incomplete, e.g., go to step 6.3”
10) “there is not step 6.3 in the procedure”

Systems and methods herein may allow a user to input a statement and/or rule and the statement and/or rule in natural language may be applied in the same, or similar, situations throughout processes moving forward. In other words, statements and/or rules provided by a user may be propagated. For example, a user input comprising “My supervisor told me to flush this result” may cause systems and methods described herein to identify a new word “flush” and apply this new wording in methods for flagging words and/or statements.

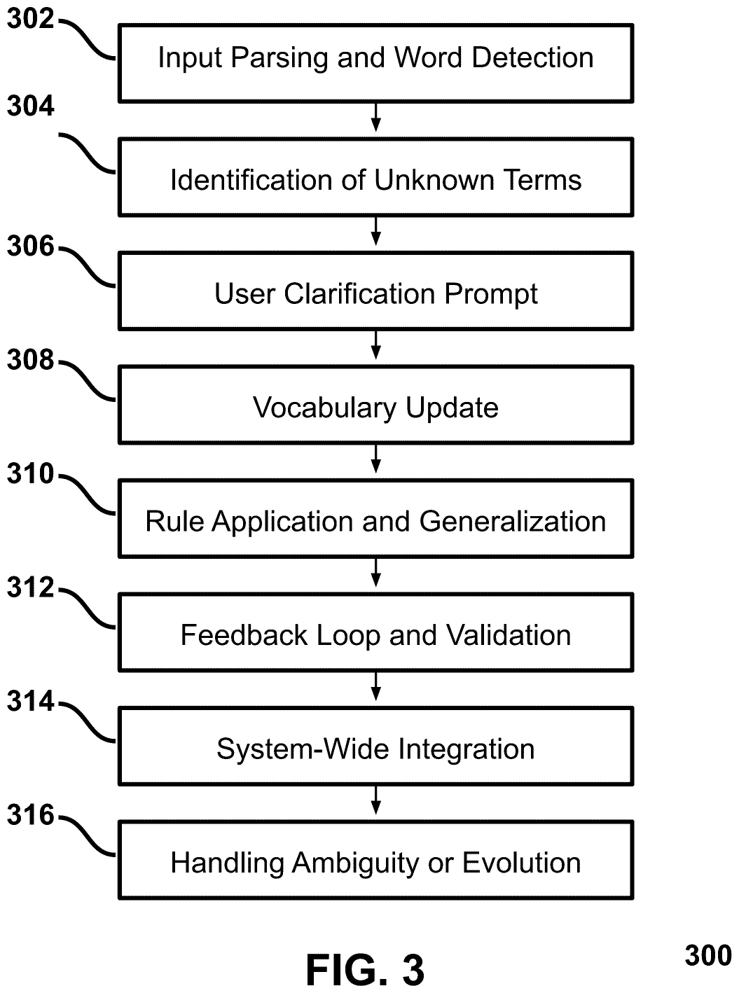

FIG. 3 is a flowchart showing a high-level description of an unknown word handling process 300, according to some embodiments herein.

At step 302, one or more inputs are parsed and/or words may be detected. For example, a user's input statements and/or rules (e.g., “My supervisor told me to flush this result”) may be scanned, parsed, tokenized, and/or broken into individual words or phrases. Natural language processing (NLP) techniques may be used to tokenize the input and identify known versus unknown terms. In some embodiments, known terms comprise words that are already stored in current vocabulary (e.g., “supervisor,” “told,” “result”). In some embodiments, unknown terms comprise words not yet defined, stored, and/or mapped to an action (e.g., “flush”) in a current vocabulary.

Systems and methods herein therefore allow for maintaining a dynamic, current dictionary, vocabulary, language model, and/or knowledge base that tracks recognized/known words and their meanings and/or associated actions, tailored to specific user preferences and/or needs, advantageously allowing for targeted and/or iterative user customization, calibration, and/or fine-tuning.

At step 304, an unknown word identification process is performed, carried out, and/or executed. In some embodiments, an unknown word (absent from current dictionary, vocabulary, and/or language model) may be entered and/or provided as part of a user statement, input, and/or rule. For example, an unknown word such as “flush” may be identified and/or detected and flagged for clarification. The unknown word may be identified and/or detected as a unique word that is not present as a key in a stored dictionary, vocabulary, and/or language model comprising key-value pairs. In some embodiments, the key may correspond and/or map to a unique word field and the value may correspond and/or map to an action field. For example, a search query may be performed on a key field corresponding to a unique field comprising single words and/or tokens to search for the unknown word. The unknown word may be identified as such and flagged if the query returns no results.

At step 306, a clarification process is performed, carried out, and/or executed if a determination is made that an unknown word has been identified. In some embodiments, the clarification process comprises providing a request to the user for a definition of the unknown word and receiving a definition from the user.

For example, the system may ask the user to define the unknown term via a prompt such as, “I don't understand what ‘flush’ means in this context. Can you explain what you mean by ‘flush this result’?” The system may wait for a user response. The user might reply, “It means to discard or ignore the result.” In some embodiments, the user may be allowed to provide a definition in natural language or select from predefined options (e.g., “Does ‘flush’ mean: a) delete, b) save, c) modify, d) something else?”).

At step 308, in response to receiving a definition for an unknown word (e.g. “flush”), a vocabulary update process is performed, carried out, and/or executed wherein the definition received from the user is stored in association with the unknown word (i.e., added to the current vocabulary and/or library), promoting the word to a known word. In some embodiments, some or all known words are associated with a definition that may comprise an action as key-value pairs, wherein a unique word field acts as a key, and a definition and/or action field acts as a value. In some embodiments, a key-value pair acts as, or defines, a rule. Accordingly, a tailored and current vocabulary, dictionary, rule set, and/or library is maintained according to user preferences and/or specifications.

At step 310, a rule application and/or generalization process is performed, carried out, and/or executed. In some embodiments, one or more rules may be created and/or updated to handle scenarios with similar contexts. For example, an input may be processed based on a similarity to known contexts. In one example, if a rule exists for known word “flush” that is associated with a definition and/or action to “disregard/ignore”, then the rule may be extended and/or generalized to synonymous and/or similar inputs such as “flush”+ [“result,” “data,” or “record”]. In some embodiments, synonymous and/or similar inputs may be flagged for review or action.

At step 312, a feedback loop and/or validation process is performed, carried out, and/or executed. In some embodiments, after a rule is applied, extended, and/or generalized, a confirmation request may be presented to a user. For example, a user may be shown a message or notification comprising “‘I've interpreted ‘flush this result’ as ‘discard this result.’ Is that correct? (Yes/No).” If the user confirms, the rule may be committed and/or solidified. If the user does not confirm, the rule may be refined based on additional input from the user, for example.

At step 314, a system integration process is performed, carried out, and/or executed. In some embodiments, the system integration propagates a rule throughout some or all of the system. For example, if another user later provides an input, “flush that entry,” the system recognizes “flush” as previously defined and/or connected with an action to “discard that entry,” it may be flagged and the same action to “discard that entry” may be performed without needing to ask any user again (unless context suggests a different meaning). In some embodiments, an update may be applied and/or deployed to some or all relevant modules (e.g., flagging mechanisms, process workflows) to recognize and act on known terms consistently.

At step 316, an ambiguity-handling, conflict-handling, and/or evolution process is performed, carried out, and/or executed. In some embodiments, the system may monitor for conflicting uses of a term and/or perform one or more processes to resolve ambiguities. For example, in some cases, different users may supply conflicting and/or inconsistent definitions and/or actions in connection with a term, such as an unknown term/word. For example, one user might specify that “flush” means “discard” and another might specify that “flush the system” means “cleanse.” In some embodiments, when an ambiguous case is identified (such as when two conflicting and/or inconsistent definitions are provided, or when a collision occurs), the system may prompt one or more users for clarification. In some embodiments, when an ambiguous case is identified (such as when two conflicting and/or inconsistent definitions are provided, or when a collision occurs), the system may use context (e.g., “result” vs. “system”) to differentiate meanings. In some embodiments, when an ambiguous case is identified (such as when two conflicting and/or inconsistent definitions are provided, or when a collision occurs), the system may maintain a confidence score for each definition and refine it based on more examples over time.

An example interaction natural language conversation-like sequence between a user and the system consistent with some embodiments is provided for illustration purposes:
1. User Input: “My supervisor told me to flush this result.”
2. System Response: “I don't understand what ‘flush’ means in this context. Can you explain what you
mean by ‘flush this result’?”
3. User Reply: “It means to discard or ignore the result.”
4. System Update: Adds “flush” to dictionary with meaning “discard/ignore” in the context of results.
5. System Confirmation: “I've interpreted ‘flush this result’ as ‘discard this result.’ Is that correct?
(Yes/No)”
6. User Reply: “Yes”
7. Future Input: “Flush that data.”
8. System Action: Flags “Flush that data” as “discard that data” and processes accordingly.

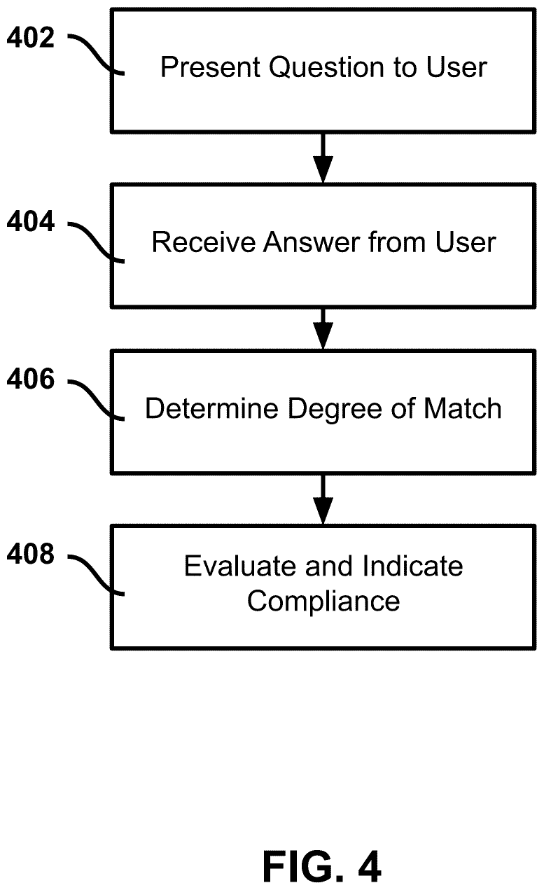

FIG. 4 is a flowchart showing a high-level description of a surveying process 400, according to some embodiments herein.

In some embodiments, systems disclosed herein are capable of a performing a method comprising presenting a question to a user, receiving an answer to the question from the user, determining a degree of match between the received answer and a predetermined answer, and in response to determining the degree of match is less than a predetermined minimum, indicating the received answer did not comply with the predetermined answer.

For example, at step 402 of surveying process 400, a first question is presented and/or displayed to a first user. In some embodiments, the first question may be selected from predefined question content based on a selection process. In some embodiments, based on the result of the selection process, a first question is displayed and/or communication to a first user. In some embodiments, the first user may be prompted to respond to the first question.

At step 404, a first input, response, and/or answer is received from the first user. In some embodiments, the first input, response, and/or answer is captured and/or stored in one or more data storage devices. In some embodiments, the first input, response, and/or answer is processed according to a response handling process.

At step 406, a matching process is performed, carried out, and/or executed. In some embodiments, the matching process is a degree matching process which may determine a degree of match between a received user input/response/answer and a predetermined and/or stored input/response/answer. For example, during a first substep of a matching process, a content similarity may be determined between a received user input/response/answer and a predetermined and/or stored input/response/answer using a text matching, semantic analysis, or scoring algorithm, which may output a similarity score (e.g., 0-100%). Further, during a second substep of a matching process, a degree of match may be assigned using the similarity score as an input. A degree of match (quantified value) may be output representing a degree of match between received and predetermined answers, for example.

At step 408, an evaluation process is performed, carried out, and/or executed. In some embodiments, the evaluation process indicates a compliance determination and/or whether a compliance criterion is met. In some embodiments, a degree of match as described herein may be an input to an evaluation function. In some embodiments, a predetermined and/or predefined minimum threshold (e.g., 80%) may be stored, accessed, and/or compared with the degree of match to threshold by the evaluation function. In some embodiments, if the degree of match is less than a predetermined minimum, a non-compliance indication may be executed, determined, and/or communicated to a user. In some embodiments, if the degree of match is not less than a predetermined minimum, an evaluation process may end, and compliance assumed.

For example, during a first substep of an evaluation process, if the degree of match is less than a predetermined minimum, a non-compliance indication may be executed, determined, and/or communicated to a user by generating one or more notifications. For example, one or more notifications may comprise visual (e.g., error message), auditory (e.g., alert sound), and/or log (e.g., record event) notifications comprising content such as “received answer did not comply with predetermined answer”. As a result, the user/system is informed of non-compliance

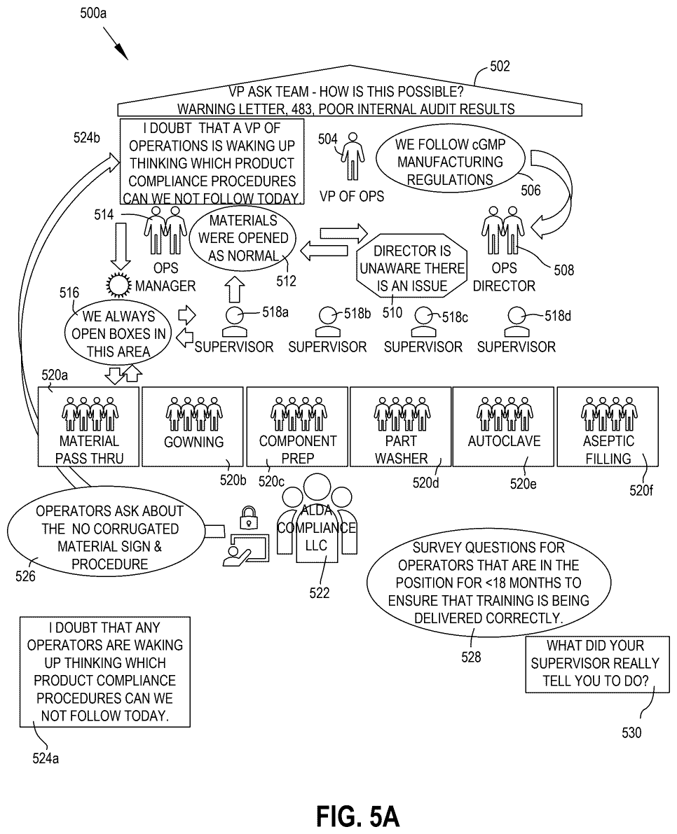

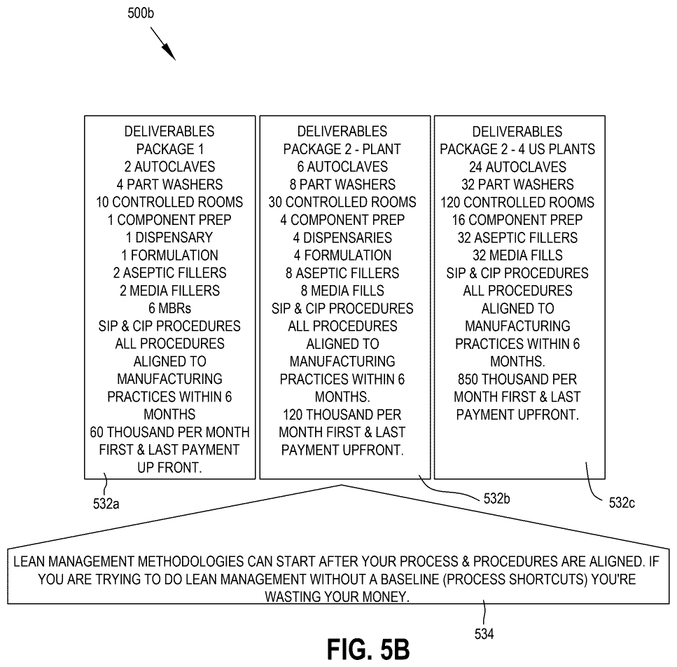

FIG. 5A depicts an aspect of a re-alignment system 500a, according to some embodiments.

In some embodiments, systems and methods herein allow for re-alignment remedies to disconnection, miscommunication, and/or information drift. For example, in some cases an organization may be directed to follow one or more compliance processes. Yet, in some cases, a non-compliant outcome may still occur, causing an organization to be left questioning how the non-complaint outcome is possible 502. In some cases, one or more operational and/or procedural disconnects may have occurred within a large process chain and/or system, which may be difficult to identify by, for example, managers and/or supervisors that are varying degrees of removed from the disconnects that believe regulations have been followed. Systems and methods herein may assist in identifying these disconnects.

For example, re-alignment system shows a management hierarchy comprising a vice president of operations (“VP of Ops”) 405, Operations Director 508, Operations Manager 514, and Supervisors 518a-518d, managing various units, roles, and/or employees 520a-520f.

VP of Ops 504 instructs Ops Director 508 to follow regulations 506, and Ops Director 508 is unaware of any issues 510, in this example.

FIG. 5B depicts an aspect of a lean management system 500b, according to some embodiments.

In some embodiments, re-alignment processes described herein enable more efficient lean management methodologies 534. For example, more granular management of deliverables packages 532a-532c may become possible and/or more easily manageable.

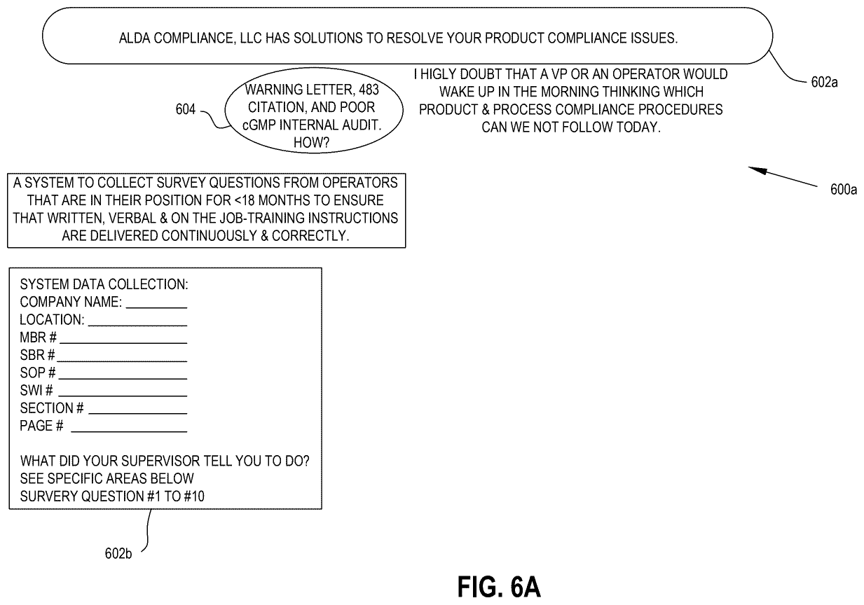

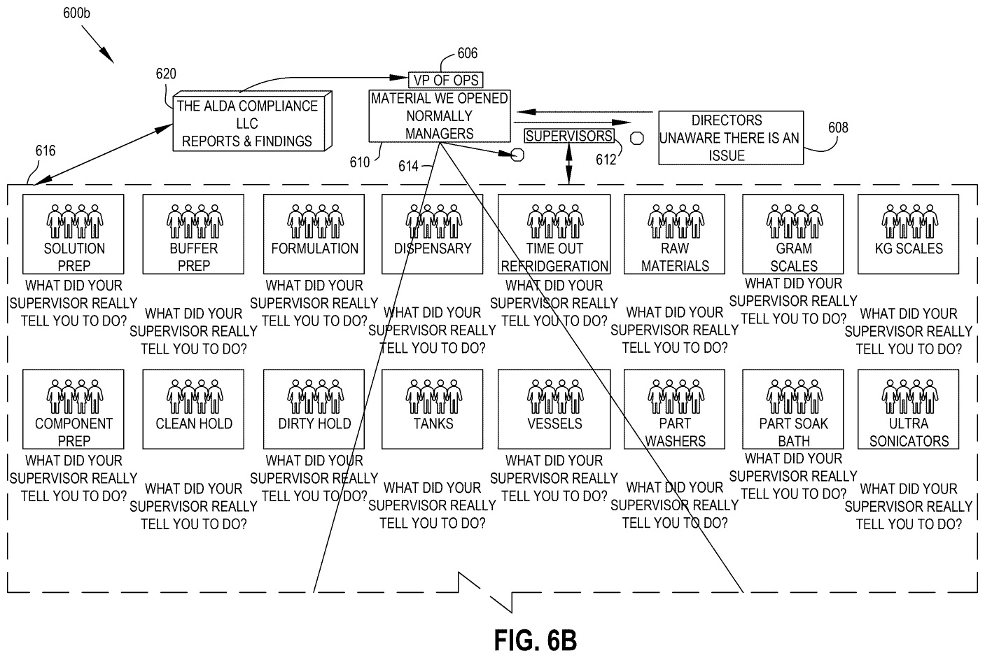

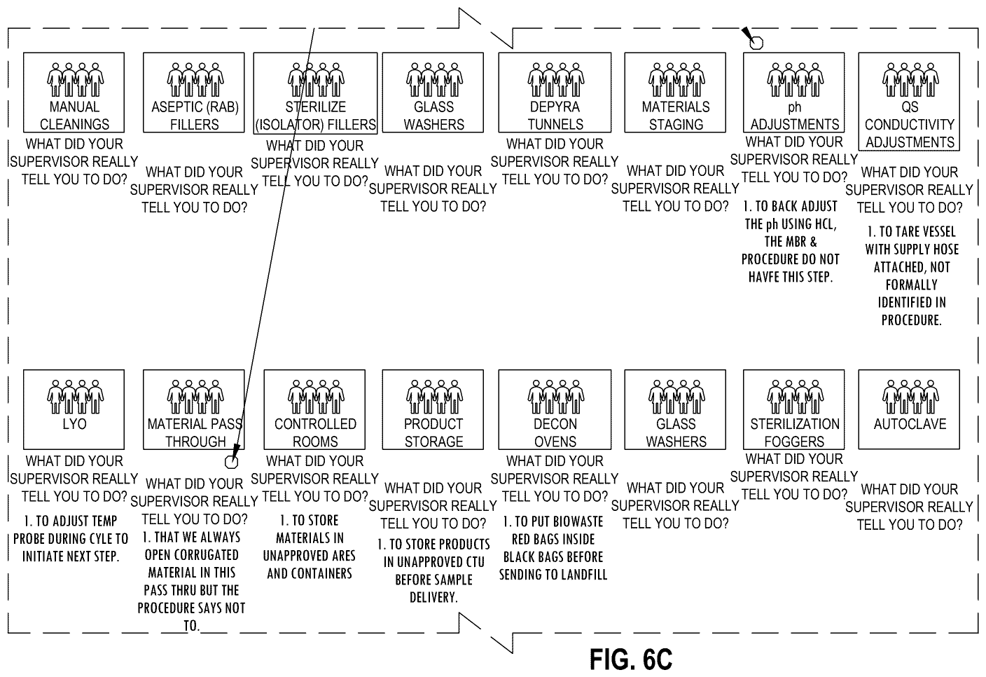

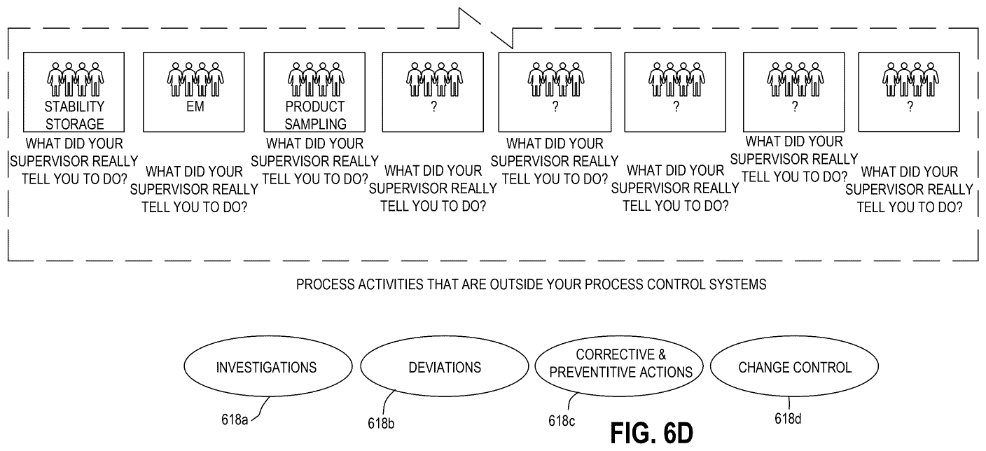

FIG. 6A depicts an aspect of a re-alignment system 600a, according to some embodiments.

In some embodiments, a system comprises a survey, information/data collection, and/or data collection/gathering utility. In some embodiments, the survey, information/data collection, and/or data gathering utility comprises a survey comprising one or more survey fields 602. In some embodiments, the survey fields comprise a company name, location, standard operating procedure (SOP) reference and/or identifier, a section, a page, and/or one or more survey questions requesting information pertaining to what was asked and/or directed of a survey recipient by a supervisor and/or manager. For example, a survey recipient may comprise an employee such as a line worker and a supervisor and/or manager may comprise the line worker's direct supervisor. The survey, information/data collection, and/or data collection/gathering utility may be deployed in response to a warning letter 604, for example, by a compliance solutions entity 602a, for example.

FIG. 6B depicts an aspect of a re-alignment system 600b, according to some embodiments.

In some embodiments, a survey, information/data collection, and/or data gathering utility may be deployed to some or all members of an organization and/or members 616 involved in a process chain and/or levels of a process chain from a compliance solutions entity 620. Compliance solutions entity 620 may be in communication with, for example, a management hierarchy comprising a vice president of operations (“VP of Ops”) 606, Operations Directors 608, and Supervisors 612, managing various units, roles, and/or employees 616.

Responses from the survey, information/data collection, and/or data gathering utility may be gathered to create an information/data feedback loop. In some embodiments, the data/information gathered in the feedback loop may be used to identify, target, and/or resolve procedural and/or operation disconnects and/or imperfections. For example, information drift may occur during communication of instructions for a particular process, such as a process subject to one or more compliance parameters. In some examples, an employee may misinterpret one or more compliance parameters and/or instructions, or be directed to ignore one or more compliance parameters and/or instructions. Analysis of data/information gathered via a feedback loop as described herein may be used to identify, target, and/or resolve procedural and/or operation disconnects and/or imperfections.

FIG. 6C depicts an aspect of a re-alignment system 600c, according to some embodiments.

In some examples, feedback information/data gathered from employees may reveal that directions to use one or more non-compliant processes and/or products were given to the employees at a particular point in a process chain. In these cases, one or more compliance points of failure may be identified.

FIG. 6D depicts an aspect of a re-alignment system 600d, according to some embodiments.

Systems and methods described herein allow for continuous data/information gathering and/or compliance and/or process evolution, allowing an organization to stay up to date with compliance processes and/or regulations. For example, based on analysis of feedback from granular data collection, investigations 618a, analysis of deviations 618b, corrective and preventative actions 618c, and change controls 618d may be implemented and/or carried out.

Although various features have been described with reference to the Drawings, other features are possible. For example, an implementation may be configured in a mobile phone app operably coupled with a cloud server and database to provide near to real time results.

Implementations may be used in any system with batch production, standard procedures, guidelines, and policies. Each manufacturing area that uses procedures can be tailored to ask specific survey questions to determine if procedures are aligned and/or have an additional comment section to identify any new anomalies that may need to be included in the survey questionnaires for other process areas. An implementation in accordance with the present disclosure may permit operators to give product quality feedback to determine instructional correctness.

### Example Embodiments

Some additional example embodiments are described and enumerated below:
1. A computer-implemented method comprising:
storing a first language-action model in a first data storage device;
wherein the first language-action model comprises a first set of key-value pairs;
wherein the key corresponds to a unique word field; and
wherein the value corresponds to an action field;
receiving a first input from a first user;
transmitting the first input to a first tokenization function;
in response to transmitting the first input to the first tokenization function, receiving a first output from the first tokenization function;
transmitting at least part of the first output to a first matching function; and
determining, by the first matching function, a degree of match between the first output and a predetermined data item.
2. The method of embodiment 1, further comprising:
identifying, by the first matching function, a first key-value pair from the first set of key-value pairs, wherein the first key-value pair comprises a first unique word and a first action;
receiving a first matching function output comprising the first key-value pair;
based on the first matching function output, identifying the first action; and
in response to identifying the first action, executing the first action.
3. The method of embodiment 1, further comprising:
establishing a first feedback loop between a first operator at a first hierarchical level of a first process chain and a compliance administrator;
wherein establishing the first feedback loop between the first operator and the compliance administrator comprises deploying a first data collection utility to the first operator, wherein the first data collection utility comprises a first analytics item directed to determining whether a first compliance criteria is met by the first process chain at the first hierarchical level of the process chain;
establishing a second feedback loop between a second operator at a second hierarchical level of the first process chain and the compliance administrator;
wherein establishing the second feedback loop between the second operator and the compliance administrator comprises deploying a second data collection utility to the second operator, wherein the second data collection utility comprises a second analytics item directed to determining whether the first compliance criteria is met by the first process chain at the second hierarchical level of the process chain.
4. The method of embodiment 1, further comprising:
establishing a first feedback loop between a first hierarchical level of an organization and a compliance administrator, wherein the first hierarchical level of the organization comprises operators that are not supervisors;
wherein establishing the first feedback loop between the first hierarchical level of the organization and the compliance administrator comprises deploying a first data collection utility to the first hierarchical level of the organization, wherein the first data collection utility comprises a first analytics item directed to determining whether a first compliance criteria is met by the first process chain at the first hierarchical level of the process chain.
5. The method of embodiment 1, further comprising:
generating a first document comprising a first report, wherein the first report comprises:
a comparison of one or more compliance requirements and first data collected from the first data collection utility; and
a comparison of the one or more compliance requirements and second data collected from the second data collection utility.
6. The method of embodiment 1, wherein the question further comprises asking what instruction the user received for a process operation.
7. The method of embodiment 1, wherein the received answer further comprises an instruction received by the user.
8. The method of embodiment 1, wherein the predetermined answer further comprises a standardized operation definition.
9. The method of embodiment 1, wherein the degree of match is determined as a function of sentence embeddings encoded as vectors in a latent space by a pretrained transformer model for received inputs and predetermined date items.
10. The method of embodiment 1, wherein the degree of match is determined at each step of the process chain, and wherein the process chain comprises a multiple operation process.
11. The method of embodiment 1, wherein multiple degrees of match are summed to determine an overall process compliance score.
12. The method of embodiment 1, wherein the method further comprises a survey with multiple questions and answers tailored to specific operations or procedures in a manufacturing process.
13. The method of embodiment 8, wherein the method is used in a drug manufacturing process.
14. The method of embodiment 1, wherein the method is triggered to be performed in response to a manufacturing process output failure.
15. The method of embodiment 10, wherein the manufacturing process output failure is detected based on sensor information.
16. A method comprising:
presenting a question to a user;
receiving an answer to the question from the user;
determining a degree of match between the received answer and a predetermined answer; and
in response to determining the degree of match is less than a predetermined minimum, indicating the received answer did not comply with the predetermined answer.
17. The method of embodiment 16, wherein the degree of match is determined as a function of sentence embeddings encoded as vectors in a latent space by a pretrained transformer model for received inputs and predetermined date items.
18. The method of embodiment 16, wherein the degree of match is determined at each step of the process chain, and wherein the process chain comprises a multiple operation process.
19. The method of embodiment 16, wherein multiple degrees of match are summed to determine an overall process compliance score.
20. The method of embodiment 16, wherein the method further comprises a survey with multiple questions and answers tailored to specific operations or procedures in a manufacturing process.
21. The method of embodiment 16, wherein the method is used in a drug manufacturing process.
22. The method of embodiment 16, wherein the method is triggered to be performed in response to a manufacturing process output failure.
23. The method of embodiment 16, wherein the manufacturing process output failure is detected based on sensor information.
24. One or more non-transitory computer-readable media that collectively store instructions that, when executed by one or more computing devices, cause the one or more computing devices to perform operations, the operations comprising some or all of any of the operations in Embodiments 1-23.
25. A computing system comprising: one or more processors; and one or more non-transitory computer-readable media that collectively store instructions that, when executed by the one or more processors, cause the computing system to perform operations, the operations comprising some or all of any of the operations in Embodiments 1-23.

In the Summary above and in this Detailed Description, and the Claims below, and in the accompanying drawings, reference is made to particular features of various implementations. It is to be understood that the disclosure of particular features of various implementations in this specification is to be interpreted to include all possible combinations of such particular features. For example, where a particular feature is disclosed in the context of a particular aspect or implementation, or a particular claim, that feature can also be used—to the extent possible—in combination with and/or in the context of other particular aspects and implementations, and in an implementation generally.

A system or method implementation in accordance with the present disclosure may be accomplished through the use of one or more computing devices. One of ordinary skill in the art would appreciate that an exemplary system appropriate for use with implementation in accordance with the present application may generally include one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with implementations of the present disclosure include, but are not limited to, proprietary computing devices, personal computers, mobile computing devices, tablet PCs, mini-PCs, servers, or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and implementation of the present disclosure are contemplated for use with any computing device.

A number of implementations have been described. Nevertheless, it will be understood that various modifications may be made. For example, the steps of the disclosed techniques may be performed in a different sequence, in some cases steps may be omitted, in some cases additional steps may be included, components of the disclosed systems may be combined in a different manner, or the components may be supplemented with other components. Accordingly, other implementations are contemplated, within the scope of the following claims.

What is claimed is:

1. A computer-implemented method comprising:
storing a first language-action model in a first data storage device;
wherein the first language-action model comprises a first set of key-value pairs;
wherein the key corresponds to a unique word field; and
wherein the value corresponds to an action field;
receiving a first input from a first user;
transmitting the first input to a first tokenization function;
in response to transmitting the first input to the first tokenization function, receiving a first output from the first tokenization function;
transmitting at least part of the first output to a first matching function; and
determining, by the first matching function, a degree of match between the first output and a predetermined data item.

2. The method of claim 1, further comprising:
identifying, by the first matching function, a first key-value pair from the first set of key-value pairs, wherein the first key-value pair comprises a first unique word and a first action;
receiving a first matching function output comprising the first key-value pair;
based on the first matching function output, identifying the first action; and
in response to identifying the first action, executing the first action.

3. The method of claim 1, further comprising:
establishing a first feedback loop between a first operator at a first hierarchical level of a first process chain and a compliance administrator;
wherein establishing the first feedback loop between the first operator and the compliance administrator comprises deploying a first data collection utility to the first operator, wherein the first data collection utility comprises a first analytics item directed to determining whether a first compliance criteria is met by the first process chain at the first hierarchical level of the process chain;
establishing a second feedback loop between a second operator at a second hierarchical level of the first process chain and the compliance administrator;
wherein establishing the second feedback loop between the second operator and the compliance administrator comprises deploying a second data collection utility to the second operator, wherein the second data collection utility comprises a second analytics item directed to determining whether the first compliance criteria is met by the first process chain at the second hierarchical level of the process chain.

4. The method of claim 1, further comprising:
establishing a first feedback loop between a first hierarchical level of an organization and a compliance administrator, wherein the first hierarchical level of the organization comprises operators that are not supervisors;
wherein establishing the first feedback loop between the first hierarchical level of the organization and the compliance administrator comprises deploying a first data collection utility to the first hierarchical level of the organization, wherein the first data collection utility comprises a first analytics item directed to determining whether a first compliance criteria is met by the first process chain at the first hierarchical level of the process chain.

5. The method of claim 1, further comprising:
generating a first document comprising a first report, wherein the first report comprises:
a comparison of one or more compliance requirements and first data collected from the first data collection utility; and
a comparison of the one or more compliance requirements and second data collected from the second data collection utility.

6. The method of claim 1, wherein the degree of match is determined as a function of sentence embeddings encoded as vectors in a latent space by a pretrained transformer model for received inputs and predetermined date items.

7. The method of claim 1, wherein the degree of match is determined at each step of the process chain, and wherein the process chain comprises a multiple operation process.

8. A computing system comprising:
one or more processors; and
one or more non-transitory computer-readable media that collectively store instructions that, when executed by the one or more processors, cause the computing system to perform operations, the operations comprising:
storing a first language-action model in a first data storage device;
wherein the first language-action model comprises a first set of key-value pairs;
wherein the key corresponds to a unique word field; and
wherein the value corresponds to an action field;
receiving a first input from a first user;
transmitting the first input to a first tokenization function;
in response to transmitting the first input to the first tokenization function, receiving a first output from the first tokenization function;
transmitting at least part of the first output to a first matching function; and
determining, by the first matching function, a degree of match between the first output and a predetermined data item.

9. The system of claim 8, the operations further comprising:
identifying, by the first matching function, a first key-value pair from the first set of key-value pairs, wherein the first key-value pair comprises a first unique word and a first action;
receiving a first matching function output comprising the first key-value pair;
based on the first matching function output, identifying the first action; and
in response to identifying the first action, executing the first action.

10. The system of claim 8, the operations further comprising:
establishing a first feedback loop between a first operator at a first hierarchical level of a first process chain and a compliance administrator;
wherein establishing the first feedback loop between the first operator and the compliance administrator comprises deploying a first data collection utility to the first operator, wherein the first data collection utility comprises a first analytics item directed to determining whether a first compliance criteria is met by the first process chain at the first hierarchical level of the process chain;
establishing a second feedback loop between a second operator at a second hierarchical level of the first process chain and the compliance administrator;
wherein establishing the second feedback loop between the second operator and the compliance administrator comprises deploying a second data collection utility to the second operator, wherein the second data collection utility comprises a second analytics item directed to determining whether the first compliance criteria is met by the first process chain at the second hierarchical level of the process chain.

11. The system of claim 8, the operations further comprising:
establishing a first feedback loop between a first hierarchical level of an organization and a compliance administrator, wherein the first hierarchical level of the organization comprises operators that are not supervisors;
wherein establishing the first feedback loop between the first hierarchical level of the organization and the compliance administrator comprises deploying a first data collection utility to the first hierarchical level of the organization, wherein the first data collection utility comprises a first analytics item directed to determining whether a first compliance criteria is met by the first process chain at the first hierarchical level of the process chain.

12. The system of claim 8, the operations further comprising:
generating a first document comprising a first report, wherein the first report comprises:
a comparison of one or more compliance requirements and first data collected from the first data collection utility;
a comparison of the one or more compliance requirements and second data collected from the second data collection utility.

13. The system of claim 8, wherein the degree of match is determined as a function of sentence embeddings encoded as vectors in a latent space by a pretrained transformer model for received inputs and predetermined date items.

14. The system of claim 8, wherein the degree of match is determined at each step of the process chain, and wherein the process chain comprises a multiple operation process.

15. One or more non-transitory computer-readable media that collectively store instructions that, when executed by one or more computing devices, cause the one or more computing devices to perform operations, the operations comprising:
storing a first language-action model in a first data storage device;
wherein the first language-action model comprises a first set of key-value pairs;
wherein the key corresponds to a unique word field; and
wherein the value corresponds to an action field;
receiving a first input from a first user;
transmitting the first input to a first tokenization function;
in response to transmitting the first input to the first tokenization function, receiving a first output from the first tokenization function;
transmitting at least part of the first output to a first matching function; and
determining, by the first matching function, a degree of match between the first output and a predetermined data item.

16. The computer-readable media of claim 15, the operations further comprising:
identifying, by the first matching function, a first key-value pair from the first set of key-value pairs, wherein the first key-value pair comprises a first unique word and a first action;
receiving a first matching function output comprising the first key-value pair;
based on the first matching function output, identifying the first action; and
in response to identifying the first action, executing the first action.

17. The computer-readable media of claim 15, the operations further comprising:
establishing a first feedback loop between a first operator at a first hierarchical level of a first process chain and a compliance administrator;
wherein establishing the first feedback loop between the first operator and the compliance administrator comprises deploying a first data collection utility to the first operator, wherein the first data collection utility comprises a first analytics item directed to determining whether a first compliance criteria is met by the first process chain at the first hierarchical level of the process chain;
establishing a second feedback loop between a second operator at a second hierarchical level of the first process chain and the compliance administrator;
wherein establishing the second feedback loop between the second operator and the compliance administrator comprises deploying a second data collection utility to the second operator, wherein the second data collection utility comprises a second analytics item directed to determining whether the first compliance criteria is met by the first process chain at the second hierarchical level of the process chain.

18. The computer-readable media of claim 15, the operations further comprising:
establishing a first feedback loop between a first hierarchical level of an organization and a compliance administrator, wherein the first hierarchical level of the organization comprises operators that are not supervisors;
wherein establishing the first feedback loop between the first hierarchical level of the organization and the compliance administrator comprises deploying a first data collection utility to the first hierarchical level of the organization, wherein the first data collection utility comprises a first analytics item directed to determining whether a first compliance criteria is met by the first process chain at the first hierarchical level of the process chain.

19. The computer-readable media of claim 15, the operations further comprising:
generating a first document comprising a first report, wherein the first report comprises:
a comparison of one or more compliance requirements and first data collected from the first data collection utility;
a comparison of the one or more compliance requirements and second data collected from the second data collection utility.

20. The computer-readable media of claim 15, wherein the degree of match is determined as a function of sentence embeddings encoded as vectors in a latent space by a pretrained transformer model for received inputs and predetermined date items.
